(19) United States
(12) Patent Application Publication
(10) Pub. No.: US 2024/0366027 A1
(43) Pub. Date: Nov. 7, 2024

(54) APPARATUS AND SYSTEMS FOR BREAST MILK AND BREAST MILK SUBSTITUTES

(71) Applicant: Milki Mama LLC, Fall Creek, WI (US)

(72) Inventor: Montana Aird, Fall Creek, WI (US)

(21) Appl. No.: 18/394,981

(22) Filed: Dec. 22, 2023

Related U.S. Application Data
(60) Provisional application No. 63/464,553, filed on May 6, 2023.

(51) Int. Cl. A47J 36/24

(52) U.S. Cl. CPC A47J 36/2438

(57) ABSTRACT

Various apparatus and systems are directed to storage, handling, and provision of breast milk. An apparatus may include a housing having a lid; a first reservoir contained within the housing and configured to receive and cool breast milk; a second reservoir contained within the housing and configured to store breast milk at a storage temperature; and a third reservoir in fluid communication with the second reservoir that is configured to warm and dispense breast milk into a breast milk receptacle.

### CROSS REFERENCE TO RELATED APPLICATIONS

This application claims benefit under 35 U.S.C. 119(e) to U.S. Provisional Patent Application Ser. No. 63/464,553, entitled “Apparatus and Systems for Breast Milk and Breast Milk Substitutes,” and filed 6 May 2023, the contents of which are incorporated herein in their entirety for all purposes.

### FIELD

The present disclosure relates to apparatus and systems for storage, handling, and provision of breast milk. The apparatus can include reservoirs for storing breast milk at refrigeration temperatures, and controlling the temperature of stored breast milk, for example, by cooling or warming to desired temperatures.

### BACKGROUND

Over 75% of women who give birth attempt to breastfeed their child. However, due to reasons varying from work obligations to mental health, a significant number of these women (greater than 85%) resort to expressing their milk via a breast pump some degree of the time. Typically, when a woman expresses her milk via a breast pump, she will have to take many steps during the process and after, resulting in a significant amount of lost time in the day.

For example, a woman will gather her pumping supplies and sit somewhere, usually attached to a wall, and pump for 20 minutes (or more) at a time, several times a day. She will then need to not only clean her supplies but ensure the proper maintenance and storage of her pumped milk.

It is crucial for a woman to store and maintain her expressed milk correctly, however this can also add up to additional hours a day that she is not able to specifically care for herself or her baby. Under current guidelines, breast milk is only considered suitable for use at room temperature (about 40° F. to about 77° F.) for up to about four hours. If refrigerated (e.g., at a temperature of about 0° F. to about 40° F.), this number jumps to four days (though it should be noted that this number drops to one day if the milk has previously been frozen and has thawed). Generally, it is believed that breast milk can be frozen (e.g., at temperatures less than about 0° F.) for up to a year.

In addition, breast milk contains important immunoglobulins, nutritional components, and vitamins. If overheated, these elements within the breast milk may be compromised and break down. Therefore, it is important to modulate temperature changes of the milk and minimize risk of heating the milk to temperatures that could cause damage to immunological and nutritional components.

A large number of women who express their breast milk have what is called an oversupply (Overactive production by the milk producing glands during lactation; this is also referred to as overproduction or overproduction syndrome), which results in an even greater time loss due to milk management. These women will usually pump for 30+ minutes, 8+ times a day, to then place the pumped milk in one receptacle in the refrigerator until it reaches a refrigerated temperature and can be combined with a larger receptacle of their earlier pumped milk. Current AAP and CDC guidelines indicate that breast milk should not be combined with milk at a different temperature, as it is believed this could jeopardize the nutritional and bacterial composition of the milk. These women will then use this larger receptacle to pour into bottles to use throughout the next day. Again, this results in a lot of lost time taking many steps and keeping track of different times.

### BRIEF SUMMARY

The present disclosure is directed to an apparatus comprising: a housing having a lid; a first reservoir contained within the housing and configured to receive and cool breast milk; a second reservoir contained within the housing and configured to store breast milk at a storage temperature; and a third reservoir in fluid communication with the second reservoir and configured to warm and dispense breast milk into a breast milk receptacle. Methods of using the apparatus to store and dispense breast milk are also described.

In some aspects, apparatus and systems described herein can maintain the fat content and nutritional level of breast milk used in feeding infants. Freshly expressed breast milk has a temperature of approximately 98.6° F. (standard body temperature). When breast milk is not used immediately after expression, it should be maintained at temperatures suitable for preserving important features of the milk such as nutritional components, immunological features, and freshness. In various aspects, apparatus and systems described herein can provide refrigeration and/or heating aspects that are desirable for the storage of breast milk and its preferred use as a nutritional fluid at or close to body temperature. In some aspects, apparatus and systems can maximize the nutritional aspect of breast milk by maintaining the breast milk at refrigerated temperatures until use, and by heating the breast milk to temperatures approximating body temperature shortly before delivery to the infant. Particularly for newborn and/or premature infants, it can be important to provide breast milk to the infant at a temperature approximating body temperature, so that the infant does not have to expend energy to warm the milk she/he consumes.

In some aspects, apparatus described herein include a cooling unit for adjusting the temperature of breast milk to a temperature that is below body and/or room temperature, such as a refrigeration (storage) temperature. In various implementations, the apparatus may further include a storage unit configured to maintain the breast milk at storage temperatures before provision to an infant. In some aspects, the apparatus includes a heating unit to warm the breast milk to a desired temperature (such as a temperature approximating standard body temperature) shortly before being provided to the infant. Thus, in various aspects, apparatus and systems described herein can provide controlled heating and cooling of breast milk that minimizes damage to the composition of the milk.

In various aspects, apparatus described herein can provide a compact system that is adapted for use in a personal setting. In some implementations, the breast milk apparatus can be provided as a countertop appliance.

### BRIEF DESCRIPTION OF THE DRAWINGS

The disclosure may be more completely understood in consideration of the accompanying drawings, in which:

FIG. 1 is a perspective front view of a breast milk apparatus in an open configuration in accordance with some implementations;

FIG. 2 is a perspective front view of a breast milk apparatus in a closed position in accordance with some implementations;

FIG. 3 is a perspective view from the back of a breast milk apparatus in accordance with some implementations;

FIG. 4 is a perspective front view of a breast milk apparatus in accordance with some implementations;

FIG. 5 is a perspective view from the back of a breast milk apparatus in accordance with some implementations.

The figures are not necessarily to scale. Like numbers in the figures refer to like components. However, it will be understood that the use of a number to refer to a component in a given figure is not intended to limit the component in another figure labeled with the same number.

### DETAILED DESCRIPTION

In the following description, reference is made to the accompanying set of drawings that form a part hereof and in which are shown by way of illustration several specific implementations. It is to be understood that other implementations are contemplated and may be made without departing from the scope or spirit of the present disclosure. The following detailed description, therefore, is not to be taken in a limiting sense.

In the following description, for purposes of explanation, numerous specific details are set forth in order to provide a thorough understanding of the present disclosure. It will be evident, however, to one skilled in the art that the present disclosure may be practiced without these specific details. The present disclosure is to be considered as an exemplification and is not intended to limit the disclosure to the specific implementations illustrated by the figures or description below.

Various embodiments of apparatus described herein may have components described by locational terms such as “up,” “upwardly,” “down,” “downwardly,” “vertically,” “laterally,” “horizontally,” “around,” “front,” “back,” “top,” “upper,” “bottom,” “lower,” and the like. These terms refer to the apparatus as it is oriented and appears in the drawings and are used for convenience only; they are not intended to be limited or to imply that the apparatus must be used or positioned in any particular manner.

In a general sense, an apparatus is provided that is configured for containing, storing, and dispensing breast milk. As used throughout this disclosure, the term “breast milk” should be given broad meaning, including mammalian breast milk, such as from humans.

In a general sense, apparatus and systems for storage, handling and provision of breast milk can include two or more reservoirs configured to receive and store breast milk under suitable conditions. In various implementations, each reservoir is configured to contain and maintain breast milk at a desired temperature. For example, a reservoir can be configured to heat or cool breast milk to a temperature in a selected range. In some aspects, a reservoir can be configured to maintain breast milk at a selected temperature for a desired amount of time.

In some implementations, an apparatus for storing breast milk can include a housing, a first reservoir contained within the housing that is configured to receive and cool breast milk; a second reservoir contained within the housing that is configured to store breast milk at a storage temperature; and a third reservoir in fluid communication with the second reservoir that is configured to warm and dispense breast milk into a breast milk receptacle. In various aspects, each reservoir is in fluid communication with at least one other reservoir, such that fluid flow can be controlled in a manner that preserves the nutritional and immunological aspects of the breast milk. In some aspects, an apparatus is configured to dispense breast milk into a breast milk receptacle, such as a bottle for infant feeding. These and other features will be described by example and through referencing the appended figures representing various implementations.

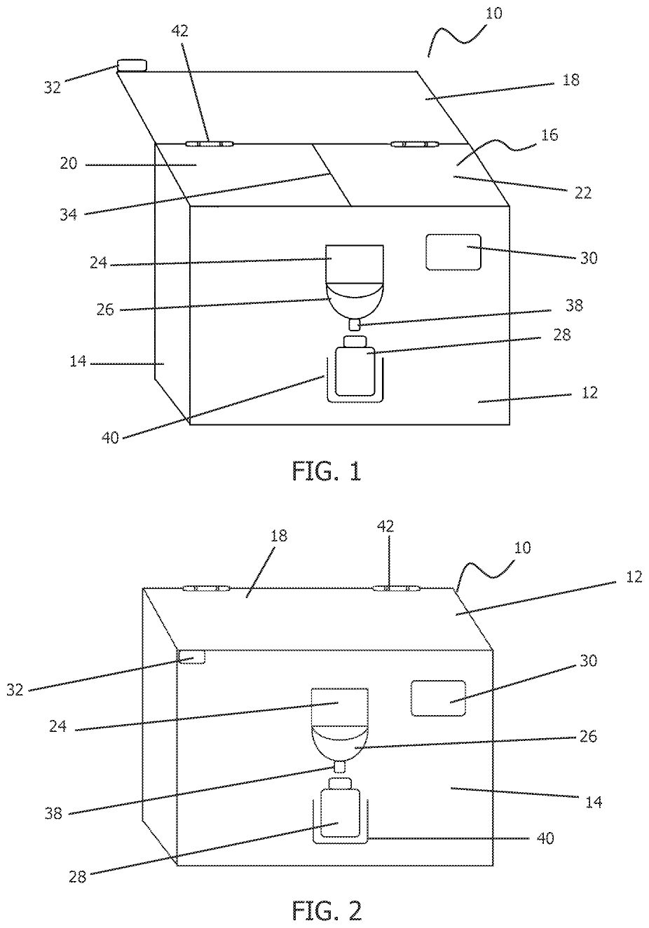

Turning to FIG. 1, an apparatus is shown in an open configuration, such that interior and exterior components can be seen. As illustrated in FIG. 1, an apparatus 10 may include a housing 12 having an exterior portion 14, an interior portion 16, and a lid 18. The interior portion can include a first reservoir 20 and second reservoir 22. The lid 18 may include a tab 32 to assist in moving the lid 18 between an open and closed position, such that access can be gained to the interior portion 16 of the housing 12. Tab 32 can be provided in any suitable configuration, for example, a piece that can be grasped and lifted to open the lid, a latch, a snap-fit portion, or other device to assist in opening the lid.

FIG. 1 illustrates lid 18 being connected to the housing 12 via a hinge 42, so that lid 18 can be opened by grasping tab 32 and pivoting the lid 18 to an open position. In some implementations, a connection other than a hinge can be provided to connect the lid 18 to the housing 12. In some embodiments, lid 18 can be provided as a separate component from the housing 12, such that lid 18 can be lifted and separated from housing 12 to expose the interior portion 16 of the housing 12. In some embodiments, lid 18 can be provided as one or more sliding doors, which may be advanced to cover the top of housing 12 when the apparatus is stored or in use. The sliding door may ride on tracks formed on the underside of the lid 18, and it may slide back and forth on the tracks to allow a user to selectively uncover the interior portion 16 of the housing 12. The lid 18 provides a secure closure for the housing 12, so that breast milk can be properly stored within the apparatus 10.

FIG. 1 illustrates a lid 18 in accordance with embodiments wherein the lid 18 spans the entire top area of housing 12. In these aspects, lid 18 can cover and/or expose both first reservoir 20 and second reservoir 22 within the interior portion. In some aspects, this may assist with cleaning and maintenance of the unit, when it is desirable to easily access both the first reservoir 20 and second reservoir 22. In some implementations, lid 18 can be configured to only expose/cover the first reservoir 20, so that the second reservoir 22 remains covered when lid 18 is opened. For example, a second lid (not shown) that covers the second reservoir 22 can be provided so that a user can selectively open the first reservoir 20, the second reservoir 22, or both reservoirs as desired; in this manner, a user would not be limited to exposing both reservoirs at the same time. This may be useful, for example, in allowing the second reservoir 22 to maintain breast milk at a desired temperature and reduce chance of contamination of the milk. In still further embodiments, lid 18 can be provided in a two-part system, such as a side-by-side bifurcated lid, or in a nested configuration, such as a lid-within-a-lid. Lid 18 can be sized to cover/expose any desired area at the top of housing 12.

In some implementations, the interior portion 16 of the housing 12 can include a first reservoir 20, a second reservoir 22, and a partition 34 that is located between and separates the first reservoir 20 from the second reservoir 22. In various aspects, the first reservoir 20 is configured to receive breast milk that is at a temperature above refrigeration temperatures (e.g., above 40° F.). In some implementations, the first reservoir 20 receives breast milk that is freshly expressed (for example, from a mother expressing breast milk using a pump). In these embodiments, the breast milk can be at or close to body temperature (about 98° F.) or slightly cooled from body temperature (for example when some time passes between expression of the milk and provision of the milk to the first reservoir 20). First reservoir 20 can be configured to cool breast milk to refrigeration temperatures (e.g., to about 35° F. to about 40° F.). Once cooled, the breast milk can be transferred to second reservoir 22 for storage.

In various aspects, second reservoir 22 is configured to store breast milk for a suitable time at a storage temperature. In some aspects, the storage temperature in the second reservoir is a refrigeration temperature, such as about 35° F. to about 40° F., or about 35° F. to about 38° F. When the storage temperature is a refrigeration temperature, the second reservoir 22 can maintain breast milk for a period of about four days or less. Thus, the first reservoir 20 and second reservoir 22 each include a cooling unit for controlling the temperature and maintaining an internal temperature within the desired ranges. In some aspects, the refrigeration temperature can be selected to be within American Academy of Pediatrics (AAP) and Centers for Disease Control and Prevention (CDC) guidelines.

In various implementations, one or more cooling units can be used in connection with the first reservoir 20, second reservoir 22, or both. A cooling unit can include one or more cooling modules, may take various forms, and may be provided in various configurations. For example, in some aspects, a cooling module can be made up of a cooling jacket (i.e., cold sink) capable of surrounding the first reservoir 20 and/or the second reservoir 22. In one implementation, a cooling module may include a Peltier thermoelectric cooler disposed between the cold sink/cooling jacket and a heat sink. The cold sink may be sized and configured to match an exterior surface of the first reservoir and/or the second reservoir. In some implementations, various other conventional cooling systems may be utilized, for example, vapor-compression refrigeration, evaporative cooling, or cold gel packs. In some implementations, a condensation air tube may be used to blow air over the cooling modules to prevent a buildup of condensation.

In some implementations, partition 34 may be configured to be removable, as discussed in more detail elsewhere herein. In some aspects, when partition 34 is removable, the cooling units may be configured to accommodate the nature of the partition. For example, the first reservoir 20 can be surrounded on three sides (i.e., the sides not including the removable partition 34) with a cooling module, and the second reservoir 22 can be surrounded on three sides (i.e., the sides not including the removable partition 34) with a cooling module. In some aspects, removable partition 34 can include insulating material to minimize heat transfer between the first reservoir 20 and second reservoir 22.

FIG. 2 illustrates an apparatus 10 having a housing 12 in a closed configuration. In these aspects, lid 18 is in a downward position so that it covers the first reservoir 20 and second reservoir 22 within the housing. As shown, the apparatus 10 can provide a convenient appliance that can be easily kept on a countertop (e.g., in a kitchen) or other suitable location.

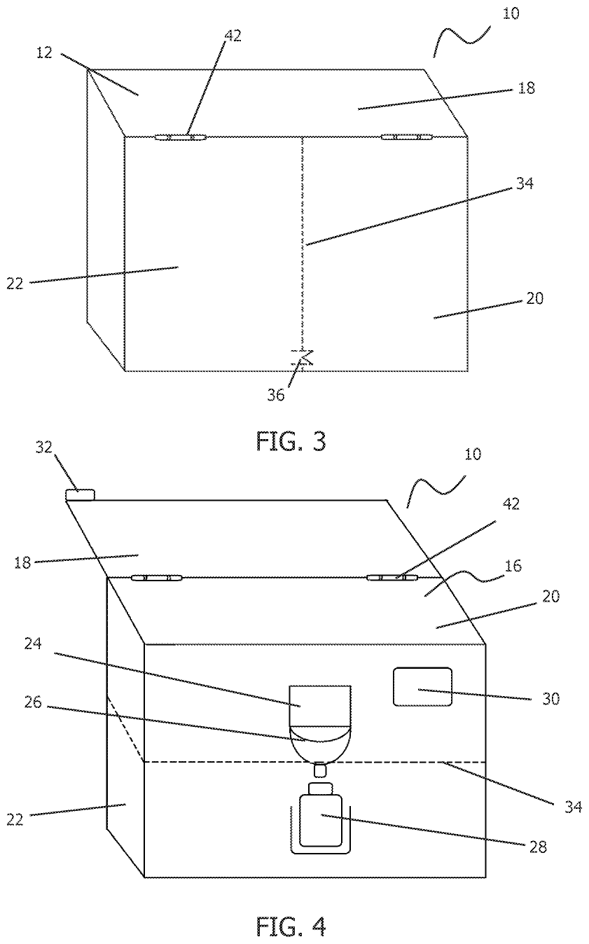

Referring to FIG. 3, a back view of a housing 12 is shown, wherein first reservoir 20 and second reservoir 22 are in a side-by-side configuration and are separated by partition 34. In various aspects, the first reservoir 20 and second reservoir 22 are in fluid communication, such that breast milk can pass from the first reservoir 20 to the second reservoir, for example, once the first reservoir has adjusted the temperature of the breast milk to a desired level. In some implementations, the desired temperature is a refrigeration temperature. Selective, fluid communication can be achieved through a valve 36. In some implementations, valve 36 can be provided by a funnel, syphon, or similar mechanism. In some aspects, the valve 36 can utilize atmospheric pressure to move breast milk from the first reservoir 20 to the second reservoir 22. In some aspects, valve 36 can be operated by a motor (e.g., a DC motor). In some implementations, valve 36 can include a backflow prevention device, such as an anti-syphon valve or the like. Valve 36 can be positioned at any desirable location along the partition 34.

In some implementations, a third reservoir 24 is provided on an exterior portion 14 of the housing 12. As illustrated in FIGS. 1, 2 and 4, a third reservoir 24 can be provided on a front face of the housing 12. In various aspects, third reservoir 24 is in fluid communication with second reservoir 22 and can be configured to receive and warm breast milk to a desired temperature that is suitable for feeding, e.g., to an infant. In some embodiments, a funnel 26 is in fluid communication with the third reservoir 24. The funnel 26 can serve to transfer warmed breast milk from the third reservoir 24 to a breast milk receptacle 28 (such as a bottle). In some aspects, funnel 26 can have a generally rounded bottom 38 (when viewed end-on from the underneath) with a circumference that is approximately the same as, or slightly smaller than, the circumference of the top of the breast milk receptacle 28.

In some implementations, a heating element and a temperature sensor (e.g., a thermocouple) can be disposed within the third reservoir 24, to heat breast milk and measure the breast milk's temperature. In some implementations, a heater can use warm air forced convection as a primary mode of heat transfer to warm breast milk to a desired temperature. In some implementations, a heater may employ either natural or forced convection, conduction, or radiation as a primary method to warm breast milk in the third reservoir 24. In still further implementations, a liquid heating system can be used, e.g., using water to provide heat to the third reservoir 24.

FIGS. 1, 2 and 4 illustrate general, relative sizes of the first reservoir 20, second reservoir 22, and third reservoir 24 in some embodiments. As illustrated, the first reservoir 20 and second reservoir 22 can be larger than the third reservoir 24. In some implementations, each of the first reservoir 20 and second reservoir 22 can be of roughly equal size (volume). In some implementations, the volume ratio of first reservoir to second reservoir to third reservoir can be 2:2:1. Generally speaking, the third reservoir 24 will be provided with a smaller size because only an amount required for a particular feeding (e.g., to an infant) will be provided to that reservoir for heating and transfer to a breast milk receptacle 28. In some implementations, third reservoir can be configured to contain 12 ounces of breast milk, or 10 ounces of breast milk.

In various implementations, the housing 12 can include a control panel 30. It will be understood that the control panel 30 can be located on any suitable exterior portion 14 of the housing, as desired, for example, a front portion, side portion, or back portion. The location of control panel 30 can be selected based on such factors as convenience and ease of access. Control panel 30 can include such features as a power button, dispense button, dispense volume selection (number of ounces desired), dispense temperature selection, memory button (to access saved pre-selected parameters), as well as volume indicators for the first and/or second reservoirs. In some implementations, control panel 30 can provide pre-set temperature options such as 60° F. (to warm chilled breast milk), 80° F. (approximately room temperature), 98° F. (approximate body temperature), as well as 103° F. and/or 110° F. (reflux). Volume indicators can include a low-milk and/or reservoir full indicator, as desired. In some aspects, control panel 30 can include a fill water indicator, for example, when the heating and/or cooling elements utilize circulated water.

In some aspects, an apparatus for storing breast milk can include a controller. A controller may be realized in the form of one or more printed circuit boards on which various electronic components are provided. The controller can be electrically coupled, e.g., via cables and connectors, to buttons or switches (e.g., provided on the control panel 30), actuators, heating elements, cooling modules, and various sensors that may be included in the apparatus.

In various implementations, a dispensing area 40 can be provided beneath the third reservoir 24 and funnel 26. Dispensing area 40 can be sized and configured to receive a breast milk receptacle 28 in a position under the bottom area 38 of funnel 26. In some embodiments, once a breast milk receptacle 28 is placed in the dispensing area 40, the bottom area 38 of funnel 26 can extend into the breast milk receptable. In these aspects, the breast milk receptacle 28 can be tilted so that the bottom area 38 of funnel 26 extends into the breast milk receptacle, then the receptacle can be pivoted so that it is placed on a platform in an upright position within the dispensing area 40. In other embodiments, the bottom area 38 of funnel 26 can be spaced from a breast milk receptacle 28 when the receptacle is placed within the dispensing area 40. Dispensing area 40 can be provided in any suitable configuration, such as an open platform, a recess having sides and a bottom (as shown in FIGS. 1-3), a recess having only sides, or the like.

In some aspects, dispensing area 40 can include a bottle sensor (e.g., a load cell, optical sensor, or the like) for detecting the presence of a bottle (breast milk receptacle) within the dispensing area 40.

Suitable breast milk receptacles can include bottles that are used to feed an infant. The particular form and shape of the breast milk receptacle 28 is not critical. For example, a suitable breast milk receptacle includes a standard 5-ounce or 8-ounce infant feeding bottle.

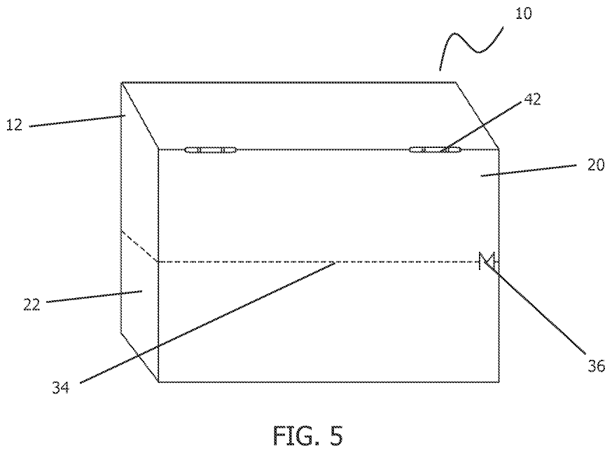

FIG. 4 illustrates an apparatus 10 including a housing 12 in an open configuration, with lid 18 hinged open to expose the interior portion 16 of the housing. In accordance with some embodiments, the first reservoir 20 and second reservoir 22 can be provided in a vertically stacked configuration (as compared to the side-by-side horizontal configuration illustrated in FIGS. 1 and 3). In these aspects, when lid 18 is moved to an open position, only the first reservoir 20 is exposed and accessible to the user. FIG. 5 illustrates a view from the back of an apparatus 10 wherein partition 34 separates the first reservoir 20 from the second reservoir 22. In various implementations a valve 36 can be included to selectively, fluidly connect the first reservoir 20 with the second reservoir 22.

In various aspects, apparatus 10 can include a level sensor within one or more of the first reservoir, second reservoir, and/or third reservoir. When included, the level sensor can measure the level of breast milk within the reservoir(s). In some embodiments, a viewing window can be included on the exterior portion of one or more reservoirs, to allow a user to visualize the amount of breast milk in a particular reservoir at any time.

The apparatus may further include an agitation component, to mix or agitate the milk within one or more reservoirs (such as the first reservoir and/or the second reservoir) to minimize fat loss. The agitation component may be, for example, a rotary-sealed propeller located within the reservoir, a rotating magnetic device, an ultrasonic transducer, or the like agitating devices.

Illustrative operation of apparatus 10 will now be described. After a user has collected breast milk (for example, a mother expresses her breast milk), the milk is placed into the first reservoir 20 by opening lid 18 and providing (e.g., pouring) the breast milk into the first reservoir 20. The breast milk is maintained in the first reservoir 20 for a suitable time to cool the milk to a temperature in a range of about 35° F. to about 40° F. Once this temperature is reached, the milk is moved into the second reservoir 22 by passing through valve 36. Once contained in the second reservoir 22, the milk is maintained at a refrigerated temperature (for example, in a range of about 35° F. to about 38° F.). Breast milk can be maintained in this state within the second reservoir 22 for a suitable amount of time, keeping in mind guidelines for preserving characteristics of the breast milk, such as nutritional value, immunological value, freshness, and the like.

When a caregiver desires to retrieve breast milk to feed an infant, the caregiver places a bottle in the dispensing area 40 and activates the dispensing function of the apparatus 10, for example by pushing a dispense button. If not done so previously, the caregiver can input the number of ounces of breast milk desired. In some aspects, the caregiver can select a desired dispensing temperature (e.g., the temperature at which the breast milk will be provided into the bottle). In some aspects, apparatus 10 can include pre-set dispensing volumes (e.g., 2 ounces, 4 ounces, 5 ounces, 6 ounces, and the like), and/or pre-set dispensing temperatures. In some implementations, apparatus 10 can include a memory function that stores a user's frequently used settings.

Once the desired amount of milk has been selected, breast milk is moved from the second reservoir 22 to the third reservoir 24. In various implementations, breast milk can pass through a valve that is actuated when a user activates the apparatus, and that opens to allow milk to move from the second reservoir 22 to the third reservoir 24. Once within third reservoir 24, the breast milk is warmed to the desired temperature before being funneled into the bottle for the caregiver to take.

In accordance with some aspects, partition 34 can be provided as a removable element of apparatus 10. In these aspects, once partition 34 is removed, apparatus 10 essentially includes one interior reservoir that is a combination of the first reservoir 20 and second reservoir 22. These aspects can be useful in situations where a user desires a larger capacity interior reservoir within the apparatus 10. For example, a user could take a full day's worth of breast milk (e.g., from a freezer stash) and provide that full day's amount into the interior reservoir for easy dispensing throughout the day. Once contained in the interior reservoir, the milk is maintained at a refrigerated temperature (for example, in a range of about 35° F. to about 38° F.). Breast milk can be maintained in this state within the interior reservoir for a suitable amount of time, keeping in mind guidelines for maintain characteristics of the breast milk, such as nutritional value, immunological value, freshness, and the like. The user may then dispense milk as described elsewhere herein.

In some implementations, pre-mixed baby formula can be added by a user. In these aspects, baby formula can be provided to the first reservoir 20, the second reservoir 22, and/or the combined interior reservoir (when partition 34 is removed) and mixed. This can be desirable, for example, to supplement the breast milk.

In some implementations apparatus 10 can be used with baby formula. In these aspects, a user can prepare a bulk amount of baby formula by combining water and formula powder, then add the bulk amount of the baby formula to apparatus 10 for use during an extended period. Once within the apparatus 10, the baby formula can be treated in accordance with the methods described herein.

The present disclosure is not to be limited in terms of the particular implementations described in this application, which are intended as illustrations of various aspects. Moreover, the various disclosed implementations can be interchangeably used with each other, unless otherwise noted. Many modifications and variations can be made without departing from its spirit and scope, as will be apparent to those skilled in the art. Functionally equivalent methods and apparatuses within the scope of the disclosure, in addition to those enumerated herein will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular implementations only and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” In addition, where features or aspects of the disclosure are described in terms of Markush groups, those skilled in the art will recognize that the disclosure is also thereby described in terms of any individual member or subgroup of members of the Markush group.

What is claimed is:

1. An apparatus comprising:
a housing having a lid;
a first reservoir contained within the housing and configured to receive and cool breast milk;
a second reservoir contained within the housing and configured to store breast milk at a storage temperature;
a third reservoir in fluid communication with the second reservoir that is configured to warm and dispense breast milk into a breast milk receptacle.

2. The apparatus of claim 1 wherein the third reservoir is located at an exterior portion of the housing.

3. The apparatus of claim 1 wherein the first reservoir is configured to cool breast milk to a temperature in a range of 35° F. to 40° F.

4. The apparatus of claim 1 wherein the second reservoir is configured to maintain breast milk at a temperature in a range of 35° F. to 38° F.

5. The apparatus of claim 1 wherein the third reservoir is smaller than each of the first reservoir and the second reservoir.

6. The apparatus of claim 5 wherein the third reservoir is configured to contain up to 10 ounces of fluid.

7. The apparatus of claim 1 further comprising a funnel in fluid communication with the third reservoir.

8. The apparatus of claim 7 wherein the circumference of the funnel at its bottom portion is less than the circumference of a breast milk receptacle.

9. The apparatus of claim 1 comprising a removable partition between the first reservoir and the second reservoir.

10. The apparatus of claim 9 wherein the removable partition includes an insulating material.

11. The apparatus of claim 1 wherein the lid is connected to the housing via a hinge.

12. The apparatus of claim 1 wherein the lid is a separate component from the housing.
